(19) United States
(12) Patent Application Publication
(10) Pub. No.: US 2010/0081050 A1
(43) Pub. Date: Apr. 1, 2010

(54) PRISMATIC SECONDARY CELL

(75) Inventors: Yasutomo Taniguchi, Minamiawaji-shi (JP); Takashi Kondou, Itano-gun (JP); Yasuhiro Yamauchi, Sumoto-shi (JP); Toshiyuki Nohma, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/568,778

(22) Filed: Sep. 29, 2009

(30) Foreign Application Priority Data
Sep. 30, 2008 (JP) 2008-254428

(51) Int. Cl. H01M 6/12

(52) U.S. Cl. 429/162

(57) ABSTRACT

An object of the present invention is to provide a high-output prismatic secondary cell that excels in current collecting efficiency and provides for reliable and highly productive welding with a lower welding current at the time of resistive welding of a current collecting plate onto a core exposed portion of a flat electrode assembly having at both ends a positive electrode core and a negative electrode core. This object is realized by a prismatic secondary cell including: a flat electrode assembly comprising a plurality of first electrode cores and a plurality of second electrode cores, the first electrode cores protruding from one end of the flat electrode assembly while being directly laminated on top of each other, the second electrode cores protruding from another end of the flat electrode assembly while being directly laminated on top of each other; and a first current collecting plate arranged in a first electrode core collected area where the mutually directly laminated first electrode cores protrude, the first current collecting plate being resistive-welded on one plane parallel to a plane on which the first electrode cores are laminated. A first electrode core melt-attached portion where the mutually directly laminated first electrode cores are melt-attached is formed in an area distanced from the area in which the first current collecting plate is attached.

### BACKGROUND OF THE INVENTION

1. Field of the Invention

The present invention relates to a prismatic secondary cell and particularly to a high-output prismatic secondary cell that excels in current collecting efficiency and provides for reliable welding with a lower welding current at the time of resistive welding of a current collecting plate onto a core exposed portion of a flat electrode assembly having at both ends a positive electrode core and a negative electrode core.

2. Background Art

In recent years, electric vehicles, including hybrid vehicles, which use secondary cells as driving power sources, are becoming popular. The electric vehicles need high-output secondary cells. Improvements in output are also in demand in mobile electronic applications such as mobile phones and laptop computers due to increasing functional improvements.

Improving the output of cells involves enlarging the opposed area of the positive and negative electrodes. In this regard, high output is facilitated with laminate electrode assembly structures comprising many positive and negative electrode plates laminated on top of one another or with wound electrode assembly structures comprising long positive and negative electrode plates wound with separators therebetween, because the opposed area of the positive and negative electrodes can be enlarged.

For stable exploitation of current, the high-output cells of these structures employ such a structure that a current collecting plate is welded onto the core exposed portions of the positive and negative electrode plates and connected to an external terminal. Additionally, it is common practice to secure two or more points for welding, from the fact that the larger the number of points of connection between the current collecting plate and the positive and negative cores, the larger the amount of stably exploited current becomes (see patent document 1).

Assuming that a plurality of welding points are secured for resistive welding of the current collecting plate onto the core exposed portions, the current expands horizontally at second and later times of welding and flows through the preceding welded points, as shown in FIG. 5. Such current is a current that is not contributory to welding, i.e., an invalid current, and therefore a necessary current cannot be allowed to flow through a desired welded point. In the meanwhile, increasing the voltage to allow a necessary amount of current to flow through a desired welded point causes sputtering to occur, resulting in the problem of failure to provide for welding of good quality.

Patent documents 2 and 3 propose techniques to overcome drawbacks encountered at the time of resistive welding of the current collecting member and the core. Specifically, a plurality of divided current collecting plate members are arranged on a common plane of an edge of the core in the plane direction, and each current collecting plate is brought into contact with a pair of welding electrodes so as to allow a welding current to flow through the current collecting plate. However, with the techniques of patent documents 2 and 3, the current collecting plate is welded onto the plane-direction edge of the core, which is weak in strength, and thus it is difficult to enlarge the welding area, failing to sufficiently improve the current collecting efficiency. Additionally, the documents involve specialized techniques in welding, which degrades the productivity of the cells.

Patent Document 1: Japanese Patent Application Publication No. 2006-12830.

Patent Document 2: Japanese Patent Application Publication No. 2002-164035.

Patent Document 3: Japanese Patent Application Publication No. 2002-184451.

### SUMMARY OF THE INVENTION

In view of the above circumstances, it is an object of the present invention to provide a high-output prismatic secondary cell that excels in current collecting efficiency and provides for reliable and highly productive welding with a lower welding current at the time of resistive welding of a current collecting plate onto a core exposed portion of a flat electrode assembly having at both ends a positive electrode core and a negative electrode core.

In order to accomplish the above and other objects, the present invention is configured as follows.

A prismatic secondary cell includes:

a flat electrode assembly comprising a plurality of first electrode cores and a plurality of second electrode cores, the first electrode cores protruding from one end of the flat electrode assembly while being directly laminated on top of each other, the second electrode cores protruding from another end of the flat electrode assembly while being directly laminated on top of each other; and

a first current collecting plate arranged in a first electrode core collected area where the mutually directly laminated first electrode cores protrude, the first current collecting plate being resistive-welded on one plane parallel to a plane on which the first electrode cores are laminated,

wherein a first electrode core melt-attached portion where the mutually directly laminated first electrode cores are melt-attached is formed in an area distanced from the area in which the first current collecting plate is attached.

With this configuration, in a part of the first electrode core collected area, where the first electrode cores are directly laminated on top of each other, there is provided a first electrode core melt-attached portion where the plurality of mutually directly laminated first electrode cores are melt attached to each other. This first electrode core melt-attached portion acts as a current bypass through which electricity generated at an active material layer of the first electrode flows to the first current collecting plate. This bypass works to reduce the electrical resistance in the electrification between the first current collecting plate and the first current collecting plate, thereby improving the current collecting efficiency.

Since the first electrode core melt-attached portion is formed in an area distanced from the area in which the first current collecting plate is attached, each of the first electrode core melt-attached portion and the first current collecting plate welded portion will not hinder the other's welding work. That is, in the formation of the first electrode core melt-attached portion by melting and integrating the first electrode core through electrical resistive welding, even if the first current collecting plate is welded first, no invalid current (that is not contributory to welding) will flow through the welded point of the previously welded first current collecting plate. Additionally, in attaching the first current collecting plate to the first electrode core through electrical resistive welding, no invalid current will flow through the previously welded first electrode core melt-attached portion. Thus, with the above configuration, electrical resistive welding of good quality can be carried out smoothly, thereby realizing a high-output prismatic secondary cell excellent in current collecting efficiency.

Since the current collecting plate is arranged and resistive-welded on one plane parallel to a plane on which the plurality of electrode cores are laminated, the welded area can be easily enlarged. Additionally, since no complicated techniques are required in the resistive welding, excellent productivity is obtained.

In the above configuration, a first current collecting plate receiving member may be attached on an opposing side of the resistive welding portion of the first current collecting plate.

In order to secure an efficient flow of welding current in attaching the first current collecting plate to the first electrode core collected area through resistive welding, it is preferable to carry out the welding with a first current collecting plate receiving member arranged on an opposing side of the resistive welding portion of the first current collecting plate. In this case, the first current collecting plate receiving member is welded and fixed to the first electrode core collected area to enhance the strength of the welded portion.

In the above configuration, a first electrode core welding member may be attached to the first electrode core melt-attached portion, and a first electrode core welding member receiving member may be attached to an opposing side of a plane on which the first electrode core welding member is attached.

In order to secure an efficient flow of welding current through the welded portion also in the resistive welding for forming the first electrode core melt-attached portion, it is preferable to carry out the welding with a welded material (on the current collecting plate side) and a welded material receiving member (on the current collecting plate receiving member side). In this case, a remaining part of each of the welded material and the welded material receiving member enhances the strength of the welded portion.

In the prismatic secondary cell according to the present invention, the first electrode may be a positive electrode or a negative electrode. The second electrode may also be attached with a second current collecting plate and have a core melt-attached portion. In the case where only the first electrode employs the current collecting plate and the core melt-attached portion according to the present invention, a current collecting plate for the second electrode may be attached by a known attaching method, examples including ultrasonic welding.

In this regard, in the case where the first electrode is a positive electrode, the first electrode core and the first current collecting plate each preferably comprise aluminum or an aluminum alloy. In the case where the first electrode is a negative electrode, the first electrode core and the first current collecting plate each preferably comprise copper or a copper alloy.

Likewise, the welded material and the welded material receiving member each preferably comprise aluminum or an aluminum alloy on the positive electrode side and copper or a copper alloy on the negative electrode side.

The above-described aluminum, aluminum alloy, copper, and copper alloy are all materials of good electrical conductivity and good thermal conductivity. Thus, as opposed to the resistive welding of conventional techniques, which requires flow of a large amount of current and thus easily encounters dust due to sputtering, the prismatic secondary cell according to the present invention realizes high quality electrical resistive welding, as described above, thereby sufficiently realizing the advantageous effect of high current collecting efficiency. However, it is not preferable to reverse the positive electrode side and the negative electrode side, that is, use copper on the positive electrode side and aluminum on the negative electrode side, because there is a possibility of degradation (dissolution) of the copper or aluminum depending on the potential.

The core, current collecting plate, current collecting plate receiving member, welded material, and welded material receiving member according to the present invention may comprise the same metal or different metals.

The flat electrode assembly used in the prismatic secondary cell according to the present invention may be either a wound electrode assembly or a laminate electrode assembly insofar as the above-described configuration is secured. Additionally, the present invention will not limit the kind of secondary cell but is applicable to, for example, non-aqueous electrolyte secondary cells, nickel-cadmium storage cells, and nickel-hydrogen storage cells.

Thus, the present invention realizes a high-output prismatic secondary cell that excels in current collecting efficiency, provides for reliable welding with a lower welding current, and reduces short circuiting caused by dust due to sputtering.

### BRIEF DESCRIPTION OF THE DRAWINGS

FIG. 1 is a perspective view of the prismatic secondary cell according to the present invention.

FIG. 2 is a diagram for illustrating an electrode assembly used in the prismatic secondary cell according to the present invention.

FIG. 3 is a diagram for illustrating positive and negative electrode plates used in the prismatic secondary cell according to the present invention.

FIGS. 4A, 4B, and 4C are diagrams for illustrating a method for attaching a current collecting plate to the electrode assembly in the prismatic secondary cell according to the present invention: FIG. 4A shows a first point of welding of the current collecting plate, FIG. 4B shows a second point of welding of the current collecting plate, and 4C shows formation of a core melt-attached portion.

FIG. 5 is a diagram for illustrating a method for attaching a current collecting plate to the electrode assembly in a conventional prismatic secondary cell.

### DETAILED DESCRIPTION OF THE INVENTION

### Embodiment

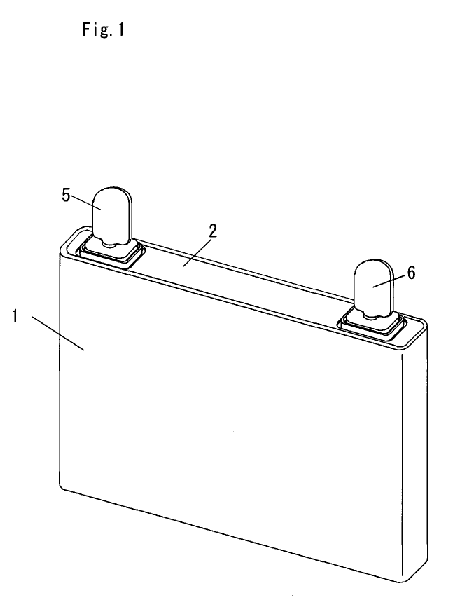

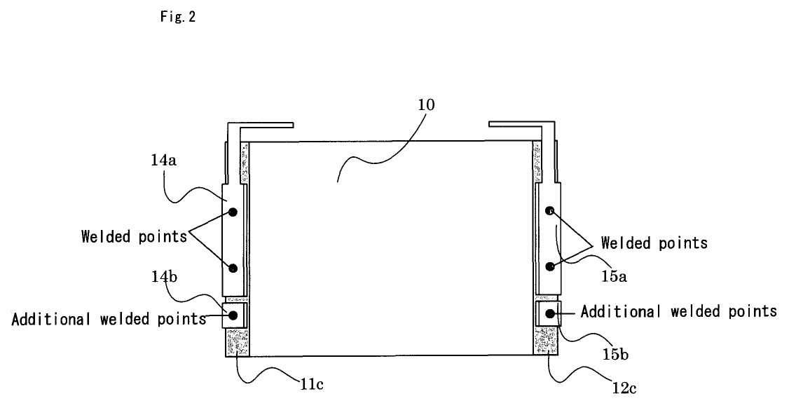

An embodiment of the present invention will be described in detail with reference to examples, where the prismatic secondary cell according to the present invention is applied to lithium ion secondary cells. FIG. 1 is a diagram for illustrating a lithium ion secondary cell according to this embodiment. FIG. 2 is a diagram for illustrating an electrode assembly used in the lithium ion secondary cell.

Referring to FIG. 1, the lithium ion secondary cell according to this embodiment includes a rectangular outer casing 1, a sealing body 2 for sealing an opening of the outer casing 1, and positive and negative electrode external terminals 5 and 6 that protrude externally from the sealing body 2.

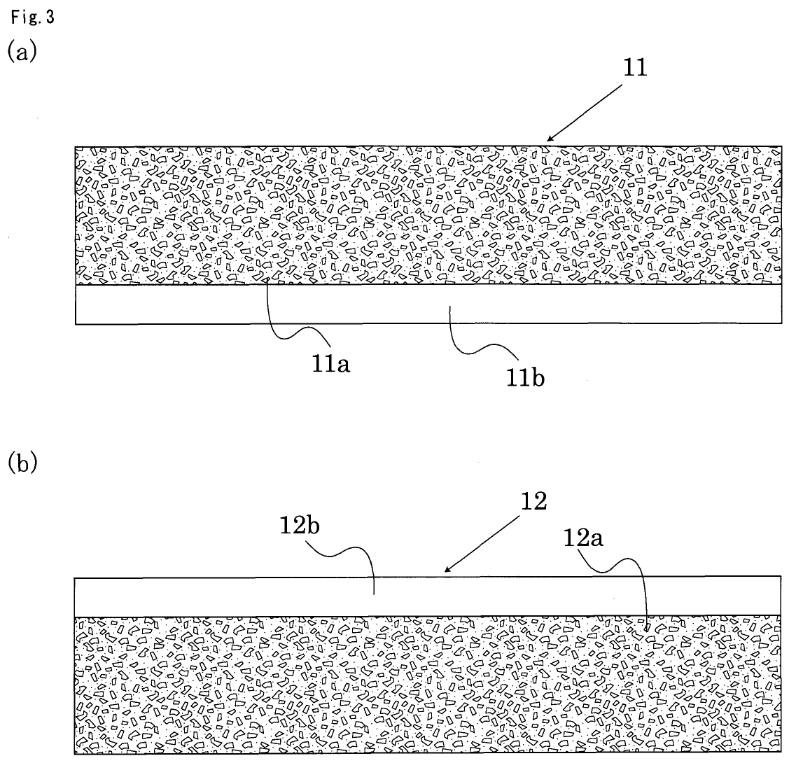

An electrode assembly 10 includes a positive electrode plate 11 and a negative electrode plate 12 (see FIG. 3) that are wound with a polyethylene porous separator therebetween. Referring to FIG. 2, a positive electrode current collecting plate 14a is fixed in a positive electrode core collected area 11c of the electrode assembly, and a negative electrode current collecting plate 15a is fixed in a negative electrode core collected area 12c of the electrode assembly. In the positive electrode core collected area 11c, a positive electrode core welded material 14b is mounted while being distanced from the positive electrode current collecting plate 14a. On an inner surface of an additional welded portion of the positive electrode core welded material 14b, a positive electrode core melt-attached portion where the plurality of mutually laminated positive electrode cores are welded is formed. The same applies to the negative electrode side; in the negative electrode core collected area 12c, a negative electrode core welded material 15b is mounted while being distanced from the negative electrode current collecting plate 15a. On an inner surface of an additional welded portion of the negative electrode core welded material 15b, a negative electrode core melt-attached portion where the plurality of mutually laminated negative electrode cores are welded is formed.

The electrode assembly 10 is housed in the outer casing 1 together with a non-aqueous electrolyte, with the positive electrode current collecting plate 14a and the negative electrode current collecting plate 15a respectively electrically connected to the external terminals 5 and 6, so that current is exploited to the outside.

FIG. 3 shows the positive and negative electrode plates 11 and 12 used for producing the electrode assembly. The positive and negative electrode plates comprise foil-like cores applied with active material layers 11a and 12a, respectively, and core exposed portions 11b and 12b, respectively, on one edge of each plate in the longitudinal direction. Such positive and negative electrode plates 11 and 12 are arranged with the separator therebetween in such a manner that the positive electrode core exposed portion 11b protrudes from one end of the wound electrode assembly and the negative electrode core exposed portion 12b protrudes from the other end. The resulting product is then wound and pressed, thus preparing a flat electrode assembly. The protruding positive and negative electrode core exposed portions act as the positive and negative electrode core collected area 11c and 12c. Alternatively, the positive and negative electrode plates may have core exposed portions on both edges of each plate in the longitudinal direction. However, in this case, the weight energy density degrades.

### Example 1

The present invention will be described in more detail with reference to an example.

<Preparation of the Positive Electrode>

A cobalt lithium compound oxide (LiCoO₂) as a positive electrode active material, a carbon conducting agent such as acetylene black and graphite, and polyvinylidene fluoride (PVDF) as a binding agent were sampled at a mass ratio of 90:5:5 and mixed in an organic solvent made of N-Methyl-2-Pyrrolidone (NMP), thus preparing a positive electrode active material slurry.

Next, using a die coater or a doctor blade, the positive electrode active material slurry was applied onto both surfaces of a positive electrode core made of an aluminum foil (20 μm thick) in the form of a band so that the thickness would be uniform. It should be noted that the slurry was not applied to one edge of the positive electrode core in the longitudinal direction (edge being in the same direction on both surfaces) so as to expose the core, thus forming a positive electrode core exposed portion.

This electrode plate was passed through a drier to remove the organic solvent and extended in a roll presser to a thickness of 0.06 mm, thus preparing a dry electrode plate. The dry electrode plate thus prepared was cut into strips of 100 mm wide, thus obtaining a positive electrode plate provided with a positive electrode core exposed portion of a 10 mm-wide aluminum band (see FIG. 3A).

<Preparation of the Negative Electrode>

Artificial graphite with an average volume particle diameter of 20 μm as a negative electrode active material, styrene-butadiene rubber as a binding agent, and carboxymethyl-cellulose as a thickening agent were sampled at a mass ratio of 98:1:1 and mixed in a suitable amount of water, thus preparing a negative electrode active material slurry.

Next, using a die coater or a doctor blade, the negative electrode active material slurry was applied onto both surfaces of a negative electrode core made of a copper foil (15 μm thick) in the form of a band so that the thickness would be uniform. It should be noted that the slurry was not applied to one edge of the negative electrode core in the longitudinal direction (edge being in the same direction on both surfaces) so as to expose the core, thus forming a negative electrode core exposed portion.

Then, this electrode plate was passed through a drier to remove moisture and extended in a roll presser to a thickness of 0.05 mm, thus preparing a dry electrode plate. The dry electrode plate thus prepared was cut into strips of 110 mm wide, thus obtaining a negative electrode plate provided with a negative electrode core exposed portion of an 8 mm-wide aluminum band (see FIG. 3B).

<Preparation of the Electrode Assembly>

The positive electrode plate, the negative electrode plate, and a separator (0.022 mm thick) made of a polyethylene porous film were laminated on top of each other and positioned in such a manner that a plurality of the same electrode core exposed portions were directly laminated on top of each other and different electrode core exposed portions would protrude in reverse directions relative to the winding direction, with the separator disposed between the active material layers. The resulting product was wound with a winding machine, taped with an insulating tape, and then pressed, thus completing a flat electrode assembly.

<Attachment of the Current Collecting Plate>

An aluminum positive electrode current collecting plate 14a provided with two mutually distanced convex portions (not shown) protruding to one plane side, and aluminum positive electrode current collecting plate receiving members 16a and 16b each provided with a convex portion (not shown) protruding to one plane side were prepared.

Onto one plane of the positive electrode core collected area 11c of the flat electrode assembly, the positive electrode current collecting plate 14a was applied with its convex portions on the side of the positive electrode core collected area 11c (see FIG. 2). Onto the other plane of the positive electrode core collected area 11c, the positive electrode current collecting plate receiving member 16a was applied in such a manner that the convex portion thereof would come into contact with the positive electrode core collected area 11c, and that one of the convex portions of the positive electrode current collecting plate 14a and the convex portion of the positive electrode current collecting plate receiving member 16a would oppose to one another across the positive electrode core collected area 11c.

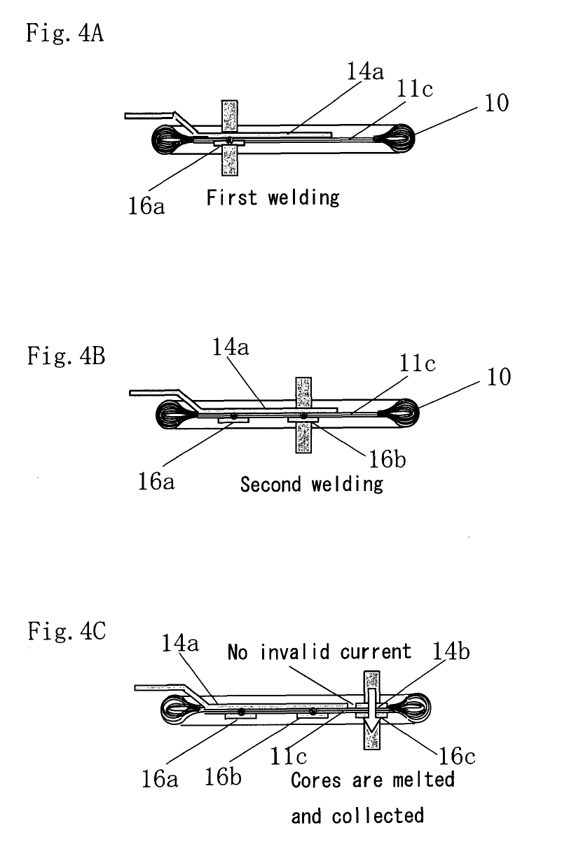

Then, onto the convex portion of the positive electrode current collecting plate 14a and the convex portion of the positive electrode current collecting plate receiving member 16a, a pair of welding electrodes were applied, followed by a flow of current through the pair of welding electrodes, thereby resistive welding the positive electrode current collecting plate 14a and the positive electrode current collecting plate receiving member 16a onto the positive electrode core collected area 11c (see FIG. 4A).

Next, onto the other plane of the positive electrode core collected area 11c, the positive electrode current collecting plate receiving member 16b was applied in such a manner that the other convex portion of the positive electrode current collecting plate 14a and the convex portion of the positive electrode current collecting plate receiving member 16b would oppose to one another across the positive electrode core collected area 11c.

Then, onto the convex portions of the positive electrode current collecting plate 14a and of the positive electrode current collecting plate receiving member 16b, a pair of welding electrodes were applied, followed by a flow of current through the pair of welding electrodes, thus carrying out resistive welding of a second point (see FIG. 4B).

<Formation of the Core Melt-Attached Portion>

An aluminum positive electrode core welded material 14b provided with a convex portion (not shown) protruding to one plane side, and an aluminum positive electrode core welded material receiving member 16c provided with a convex portion (not shown) protruding to one plane side were prepared.

The positive electrode core welded material 14b was applied onto the plane of the positive electrode core collected area 11c on the side of the positive electrode current collecting plate 14a while being distanced from the positive electrode current collecting plate 14a in such a manner that the convex portion of the positive electrode core welded material 14b would come into contact with the positive electrode core collected area 11c.

Next, onto the other plane of the positive electrode core collected area 11c, the positive electrode core welded material receiving member 16c was applied in such a manner that the convex portion thereof would come into contact with the other plane of the positive electrode core collected area 11c, and that the convex portion of the positive electrode core welded material 14b and the convex portion of the positive electrode core welded material receiving member 16c would oppose to one another across the positive electrode core collected area 11c.

Then, onto the convex portion of the positive electrode core welded material 14b and the convex portion of the positive electrode core welded material receiving member 16c, a pair of welding electrodes were applied, followed by a flow of current through the pair of welding electrodes to melt-attach the plurality of mutually directly laminated positive electrode cores to each other, thus forming a positive electrode core melt-attached portion. By this step, the positive electrode core welded material 14b and the positive electrode core welded material receiving member 16c were fixed to the positive electrode core collected area 11c (see FIG. 4C). Table 1 shows welding conditions (welding current value and welding time) on this occasion.

The same applied to the negative electrode side, as the positive electrode side. That is, the negative electrode current collecting plate 15a was resistive-welded onto the negative electrode core collected area 12c, and the negative electrode core exposed portions were melt-attached to each other, thus forming a negative electrode core melt-attached portion (see FIG. 2). The negative electrode current collecting plate 15a, the negative electrode current collecting plate receiving member (not shown), the negative electrode core welded material, and the negative electrode core welded material receiving member (not shown) were all made of copper.

<Preparation of the Electrolytic Solution>

In a non-aqueous solvent having mixed therein ethylene carbonate (EC), polypropylene carbonate (PC), and diethyl carbonate (DEC) at a mass ratio of 1:1:8 (at 1 atm. And 25° C.), LiPF₆ as electrolytic salt was dissolved at a rate of 1.0 (mol/liter), thus obtaining an electrolytic solution.

<Assembly of the Cell>

The positive electrode current collecting plate 14a and the negative electrode current collecting plate 14b were brought into electrical connection to a positive electrode external terminal 5 and a negative electrode external terminal 6, and jointed by caulking to the sealing body 2 through an insulating gasket (not shown). The electrode assembly 10 was integrated with the sealing body 2, and they were inserted into the outer casing 1, and the sealing body 2 was fitted to the opening of the outer casing 1. The circumference of the sealing body 2 and the jointed portion of the sealing body 2 were laser welded onto one another. From an electrolytic solution port provided on the sealing body 2 (not shown), a predetermined quantity of the electrolytic solution was injected. Then, the electrolytic solution port was sealed, thus assembling a cell according to example 1.

### Comparative Example 1

A cell according to comparative example 1 was prepared in the same manner as in example 1 except that no core melt-attached portions were formed and the number of points of welding between the current collecting plate and the core exposed portion was 2. Table 1 shows welding current values and welding time for the welding points on this occasion.

### Comparative Example 2

A cell according to comparative example 2 was prepared in the same manner as in example 1 except that no core melt-attached portions were formed and the number of points of welding between the current collecting plate and the core exposed portion was 3. Table 1 shows welding current values and welding time for the welding points on this occasion.

[Measurement of Resistance Values]

The values of resistance between the positive electrode cores and positive electrode current collecting plates of the cells of example 1 and comparative examples 1 and 2 were measured using a tester. The results are shown in table 1.

TABLE 1

| | Welding conditions | | | | |
|---|---|---|---|---|---|
| | | Second | | | |
| | First point | point | Third point | | Resistance |
| | current | current | current | Time | (mΩ) |
| Example 1 | 1.1 kA | 1.3 kA | — | 19.8 ms | 0.213 |
| Comparative | 1.0 kA | 1.3 kA | — | 19.8 ms | 0.298 |
| Example 1 | | | | | |
| Comparative | 1.2 kA | 1.6 kA | 2.2 kA | 19.8 ms | 0.250 |
| Example 2 | | | | | |

Table 1 shows that example 1, in which the core melt-attached portions are formed, has a resistance of 0.213 mΩ, which is smaller than 0.298 mΩ and 0.250 mΩ respectively for comparative examples 1 and 2, in which no core melt-attached portions are formed.

This can be considered as follows. In the presence of a core melt-attached portion, this acts as a bypass for the current collected on the current collecting plate, and thus the value of resistance between the core melt-attached portion and the current collecting plate decreases. Additionally, such bypass has superior conductivity than an additional portion where the current collecting plate and the core exposed portion are welded onto one another under usual conditions (such portion corresponding to the third welded point in comparative example 2), resulting in a resistance lower than the resistance of the case of comparative example 2, which secures a larger number of welding points between the current collecting plate and the core exposed portion.

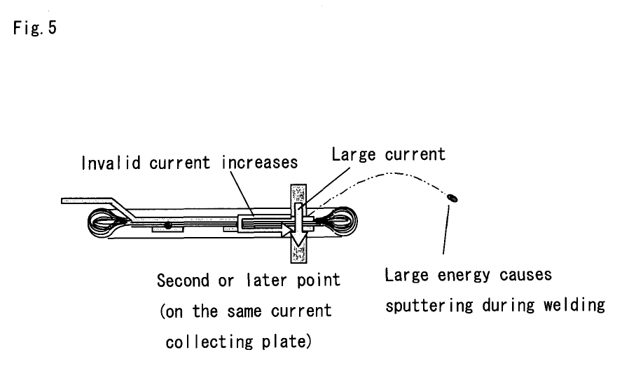

The table also shows that the larger the number of welding points becomes, the larger the value of current required for welding becomes. This can be considered as follows. This is because, as shown in FIG. 5, if the welding points increase, part of the current circumvents the previously welded portions at the time of welding the added points, thereby requiring more current to secure the necessary current to flow through the welding points.

The table also shows that comparative example 2, which secures three welding points between the current collecting plate and the core exposed portion, has a resistance of 0.250 mΩ, which is smaller than 0.298 mΩ for comparative example 1, which secures two welding points, and larger than 0.213 mΩ for example 1, which secures two welding points and has melt-attached portions.

This can be considered as follows. As described above, comparative example 2 has a larger number, namely three, of welding points than example 1, which has two welding points. Thus, in the welding of the third point, part of the flowing current circumvents the previously welded two points. Even if the welding current is increased, a sufficiently large welding area cannot be secured. Thus, the effect of increasing the welding points succumbs to the effect of forming the melt-attached portions, with the result that comparative example 2 has higher resistance than example 1.

(Supplementary Remarks)

In the present invention, the core exposed portion needs to be provided on at least one edge of each of the positive and negative electrode plates, but this will not exclude providing the core exposed portion on the opposing edges. It should be noted, however, that providing the core exposed portion on both edges causes such a disadvantage that the area of the active material layer diminishes.

Additionally, in the present invention, the positive electrode core welded material and the positive electrode current collecting plate may be welded onto the core and then electrically connected to one another. The same applies to the negative electrode side; the negative electrode current collecting plate may be electrically connected to the negative electrode core welded material. In this configuration, the positive and negative electrode core welded materials act as part of the corresponding current collecting plates, and thus the contact area of the cores and the current collecting plates increases, thereby further improving the current collecting efficiency.

In the above example, the positive electrode core, the positive electrode current collecting plate, the positive electrode current collecting plate receiving member, the positive electrode core welded material, and the positive electrode core welded material receiving member are made of aluminum, and the negative electrode core, the negative electrode current collecting plate, the negative electrode current collecting plate receiving member, the negative electrode core welded material, the negative electrode core welded material receiving member are made of copper, but this should not be construed in a limiting sense.

While in the above example the positive electrode current collecting plate, the positive electrode current collecting plate receiving member, the positive electrode core welded material, and the positive electrode core welded material receiving member are provided with protruding convex portions on the core side so as to secure effect welding current, the convex portions are not essential components of the present invention. In the case of providing a convex portion, the size of the convex portion is approximately the same as the size of the welding electrode.

The present invention is not limited to lithium ion secondary cells but applicable to other prismatic secondary cells such as nickel-hydrogen storage cells and nickel-cadmium storage cells. While in the above example a flat wound electrode assembly is used, the present invention is applicable to, for example, a prismatic secondary cell having such an electrode assembly that plate-like positive and negative electrode plates are laminated with a separator therebetween.

In the case where the present invention is applied to a lithium ion secondary cell, as the positive electrode active material, a lithium-containing transition metal complex oxide can be used such as a cobalt acid lithium, a nickel lithium complex oxide (LiNiO₂), a manganese lithium complex oxide (LiMn₂O₄), iron lithium complex oxide (LiFeO₂), and an oxide in which a part of the transition metal contained in any of the foregoing oxides is substituted by another element. These oxides can be used alone or in combination of two or more of the foregoing.

In the case where the present invention is applied to a lithium ion secondary cell, as the negative electrode material, natural graphite, carbon black, corks, glass carbon, carbon fiber, or a carbonaceous matter such as a burned substance of the foregoing, or a mixture of the carbonaceous matter and one selected from the group consisting of lithium, a lithium alloy, and a metal oxide capable of intercalating and disintercalating lithium can be used.

In the case where the present invention is applied to a lithium ion secondary cell, the non-aqueous solvent is not limited to the combinations specified in the above example: for example, a high-dielectric-constant solvent with high solubility for lithium salt can be used such as ethylene carbonate, propylene carbonate, butylene carbonate, and γ-butyrolactone, which is mixed with a low viscous solvent such as diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolan, methyl formate, ethyl formate, methyl acetate, ethyl acetate, propyl acetate, and ethyl propionate. It is also possible to use a mixture solvent of two or more high-dielectric-constant solvents and two or more low viscous solvents. As the electrolytic salt, instead of LiPF₆, for example, LiN(C₂F₅SO₂)₂, LiN(CF₃SO₂)₂, LiClO₄, or LiBF₄ can be used alone or in combination of equal to or more than two of the foregoing.

As described hereinbefore, according to the present invention, a current bypass can be formed for current collection by melt-attaching a plurality of mutually directly laminated cores that protrude from edges of the electrode assembly, thereby drastically improving the current collecting efficiency. The present invention also provides for reliable and highly productive welding with smaller consumption of power, and provides for welding joint of good quality without sputtering, thus realizing at low cost a high-output prismatic secondary cell with excellent current collecting efficiency. Therefore, the industrial applicability of the present invention is considerable.

### DESCRIPTION OF REFERENCE NUMERAL

1 Outer casing
2 Sealing body
5, 6 Electrode terminal
10 Electrode assembly
11 Positive electrode plate
12 Negative electrode plate
11a, 12a Active material layer
11b, 12b Core exposed portion
11c, 12c Core collected area
14a Positive electrode current collecting plate
14b Positive electrode core welded material
15a Negative electrode current collecting plate
15b Negative electrode core welded material
16a, 16b Positive electrode current collecting plate receiving member
16c Positive electrode core welded material receiving member

What is claimed is:

1. A prismatic secondary cell comprising:
a flat electrode assembly comprising a plurality of first electrode cores and a plurality of second electrode cores, the first electrode cores protruding from one end of the flat electrode assembly while being directly laminated on top of each other, the second electrode cores protruding from another end of the flat electrode assembly while being directly laminated on top of each other; and
a first current collecting plate arranged in a first electrode core collected area where the mutually directly laminated first electrode cores protrude, the first current collecting plate being resistive-welded on one plane parallel to a plane on which the first electrode cores are laminated,
wherein a first electrode core melt-attached portion where the mutually directly laminated first electrode cores are melt-attached is formed in an area distanced from the area in which the first current collecting plate is attached.

2. The prismatic secondary cell according to claim 1, further comprising a first current collecting plate receiving member attached on an opposing side of the resistive welding portion of the first current collecting plate.

3. The prismatic secondary cell according to claim 1, further comprising:
a first electrode core welding member attached to the first electrode core melt-attached portion; and
a first electrode core welding member receiving member attached to an opposing side of a plane on which the first electrode core welding member is attached.

4. The prismatic secondary cell according to claim 2, further comprising:
a first electrode core welding member attached to the first electrode core melt-attached portion; and
a first electrode core welding member receiving member attached to an opposing side of a plane on which the first electrode core welding member is attached.

5. The prismatic secondary cell according to claim 1, wherein:
the first electrode core is a positive electrode core; and
the first electrode core and the first current collecting plate each comprise aluminum or an aluminum alloy.

6. The prismatic secondary cell according to claim 1, wherein:
the first electrode core is a negative electrode core; and
the first electrode core and the first current collecting plate each comprise copper or a copper alloy.
